(19) United States
(12) Patent Application Publication
(10) Pub. No.: US 2007/0013605 A1
(43) Pub. Date: Jan. 18, 2007

(54) Spiral antenna

(76) Inventor: Duane Preble, White Hall, MD (US)

Correspondence Address: J. W. Gipple, P.O. Box 40513, Washington, DC, 20016, US

(21) Appl. No.: 11/180,337

(22) Filed: Jul. 14, 2005

(51) Int. Cl. H01Q 1/36

(52) U.S. Cl. 343/895

(57) ABSTRACT

An antenna is described, which is comprised of copper tubing formed into a three-dimensional Archimedes spiral, extending above and supported by a back plate.

### CROSS REFERENCE TO RELATED APPLICATIONS

N/A

### STATEMENT REGUARDING FEDERALLY SPONSORED RESEARCH FOR DEVELOPMENT

N/A

### INCORPORATED-BY-REFERENCE OF MATERIALS SUBMITTED ON COMPACT DISC

N/A

### BACKGROUND OF THE INVENTION

(1) Field of the Invention

This invention is directed to an antenna formed of copper tubing in a three dimensional spiral configuration.

The earliest and most basic means of transmitting and receiving electromagnetic waves, are thin metal elements (rods or tubes) extending upwardly (e.g. automobile radio antennae). More sophisticated antennae have a trunk metal element, to which additional metal elements are attached and extend outwardly therefrom at various angles (e.g., television reception antennae, commonly mounted on rooftops). Such antennae are by nature spindly and fragile.

The antenna that is presently most used in UHF transmission is the YAGI-UDA, which consists of an array of dipoles (metal elements) supported by and extending outwardly from a trunk tube. The trunk tube contains instrumentation necessary to its function, including a small circuit board to provide a phasing (or matching) network. This is necessary because the impedance of the antenna is different from that of the transmitter. Impedance must be the same or power is not transferred. It is reflected back to the transmitter. The matching network is necessary to insure that the impedance of the antenna is the same as the impedance of the transmitter.

The YAGI antenna, in addition to being spindly and fragile, is vulnerable to the weather. Moisture from rain or snow can penetrate the trunk tube, destroying or compromising the instrumentation contained therein. Wet leaves or Spanish moss can detune them.

It is accordingly, an object of the present invention to provide an antenna which functions as well as the YAGI but is more compact, less vulnerable, and less expensive to produce.

(2) Description of Related Art

Applicant is aware of U.S. Pat. No. 6,133,891 and the references cited therein.

### BRIEF DESCRIPTION OF THE DRAWINGS

FIG. 1 is a side perspective view of the antenna

FIG. 2 is a cross sectional view of the antenna

FIG. 3 is a side view of the antenna mounted and covered by a protective cap

FIG. 4 illustrates plastic supports for the spiral coil

### BRIEF SUMMARY OF THE INVENTION

In accordance with the present invention an antenna is provided which comprises copper tubing formed into an Archimedes spiral. The bottom end of the spiral copper coil is connected to the upper end of an electrically conductive post, the lower end of which is connected to a means for transmitting or receiving radio frequency energy. The post extends through a back plate (ground plane), but is insulated from the back plate by a dielectric material. A plurality of support struts, made of a dielectric material, extend, upwardly from back plate and engage the spiral coil to maintain the stability of its position. The antenna is mounted on support structure with means for lateral adjustment.

A protective cap of dielectric material is attached to the back plate and covers the antenna.

### DETAILED DESCRIPTION OF THE DRAWINGS

Reference will now be made in detail to the present embodiment of the invention as illustrated in the accompanying drawings.

In FIG. 1, a coil of ⅜ inch copper tube 6 is formed into a three dimensional Archimedes spiral. It extends above a back plate formed of aluminum or stainless steel which functions as a ground plane. The back plate is sixteen inches in diameter. The spiral coil 6 is conductively connected at its bottom end to post 4, by a pin 8, which extends through spiral coil 6 and post 4 and is soldered thereto. The spiral coil 6 is six inches in height and its uppermost diameter is eleven inches.

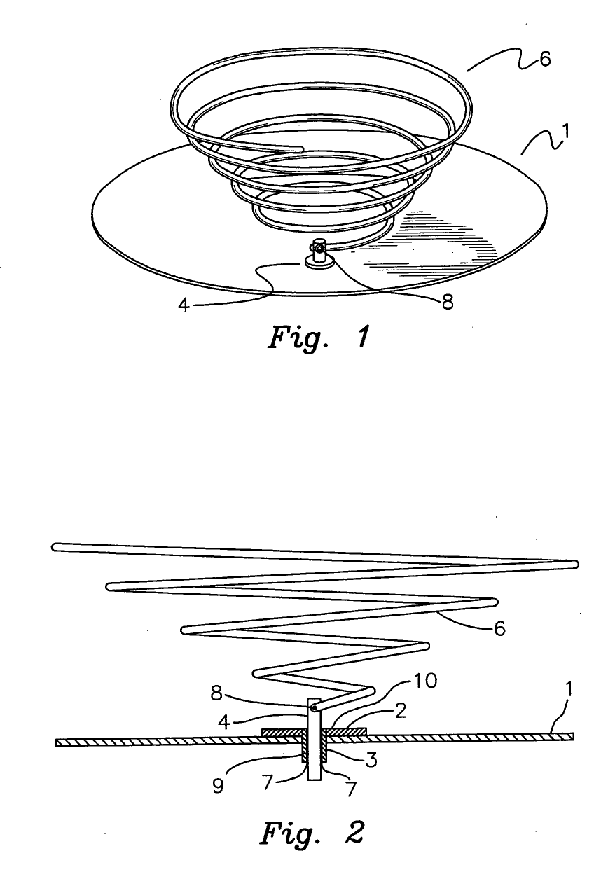

As illustrated in FIG. 2, the post 4 is part of a standard panel jack receptacle 2. It has a housing 9, with a threaded bottom 3. It has an attachment plate 10 which extends outwardly at a right angle from post 4 and parallel to the back plate 1, to which it is attached. A cylinder of dielectric material 7 insulates the post 4 from electrical contact with back plate 1.

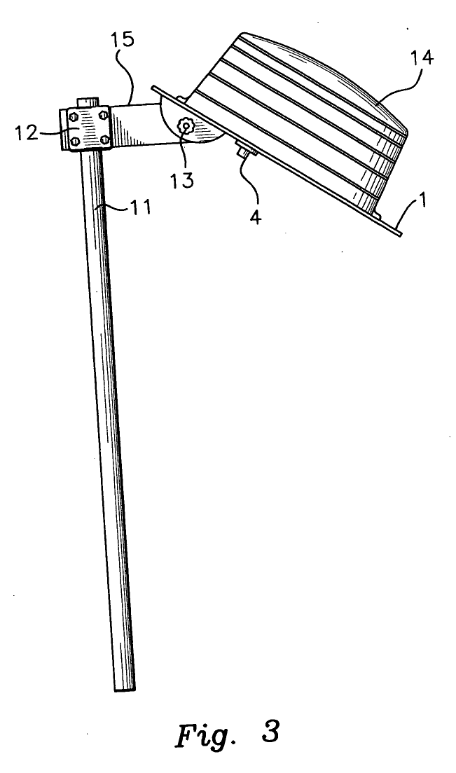

FIG. 3 illustrates the antenna of the invention as mounted on a support structure 11. It is attached by means of a vertically adjustable clamp 12. A laterally adjustable clamp 13 attaches an extension 15 of the support structure 11 to the back plate 1.

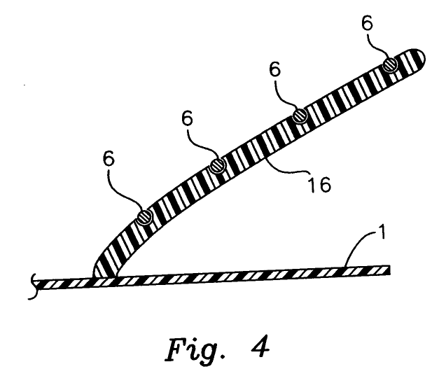

FIG. 4 illustrates one of several support struts 16, which extend around the spiral coil 6 to support it and maintain the stability of its position.

An important aspect of this invention is that the impedance of the antenna is 50 ohms, which is the same as input impedance. So no matching network is needed. This reduces manufacturing cost, and susceptibility to the effects of external items such as metal towers and bridges.

The invention, as illustrated, is wound counter clockwise, which radiates in a right hand circular pattern. If wound clockwise, it would be left hand circular polarized. An important aspect of the invention is the use of a three dimensional spiral designed so that the radiated pattern has gain (i.e. preferential energy distribution) and connects without loss to a standard transmitter or receiver.

What is claimed is:

1. An antenna for transmitting or receiving energy comprising:
a coil of electrically conductive material formed into a spiral shape, having a top end and a bottom end;
said top end being wider than said bottom end;
said bottom end of the spiral coil, being connected to a means for transmitting or receiving radio frequency energy.

2. The antenna of claim 1, which includes;
a back plate disposed beneath said bottom end of spiral coil;
a conductive post connected to said bottom end of spiral coil, and extending through said back plate to a means for transmitting or receiving radio frequency energy
means for electrically insulating said post from said back plate.

3. The antenna of claim 1, wherein said coil is formed into the shape of a three-dimensional Archimedes spiral.

4. The antenna of claim 1, wherein the antenna is mounted on structure by means that facilitate vertical adjustment.

5. the antenna of claim 1, wherein the antenna is mounted on a structure by means that facilitate lateral adjustments.

6. The antenna of claim 1, wherein said spiral coil is covered by a protective cap of dielectric material.

7. The antenna of claim 2, wherein said spiral coil is supported and held in position by dielectric support struts extending from said back plate.
